(19) United States
(12) Patent Application Publication
(10) Pub. No.: US 2026/0100762 A1
(43) Pub. Date: Apr. 9, 2026

(54) IMMUNE OPTICAL COMMUNICATIONS USING COHERENCE RANK

(71) Applicants: Brown University, Providence, RI (US); The University of Central Florida Research Foundation, Inc., Orlando, FL (US)

(72) Inventors: Kimani C. Toussaint, JR., Providence, RI (US); Mitchell Harling, Providence, RI (US); Ayman F. Abouraddy, Orlando, FL (US)

(21) Appl. No.: 19/377,831

(22) Filed: Nov. 3, 2025

Related U.S. Application Data
(60) Provisional application No. 63/703,613, filed on Oct. 4, 2024.

(51) Int. Cl. H04B 10/516; H04L 25/02

(52) U.S. Cl. CPC H04B 10/516; H04L 25/0222

(57) ABSTRACT

Methods and systems for performing rank based communications is disclosed. The method includes encoding information onto a signal using at least two different degrees of freedom of the signal. The signal has an initial coherence matrix of the degrees of freedom. The signal is transmitted through a transmission channel. A sensor detects the signal and an analyzer determines a resultant coherence matrix of the degrees of freedom from the detected signal. The analyzer diagonalizes the resultant coherence matrix and generates a diagonalized matrix. The encoded information is then determined from the diagonalized matrix.

### CROSS REFERENCE TO RELATED APPLICATIONS

The instant application claims priority from U.S. Provisional Patent Application Ser. No. 63/703,613 filed Oct. 4, 2024, the disclosure of which is incorporated herein by reference.

### GOVERNMENT LICENSE RIGHTS

This invention was made with government support under grant numbers N00014-20-1-2789 and N00014-17-1-2458 awarded by the Office of Naval Research. The government has certain rights in the invention.

### BACKGROUND

Many crucial technological facets of our daily lives, including the internet and highspeed communication, depend on lightwave systems to carry information around the world, most ubiquitously through fiber optics. Optical communication systems, whether guided (e.g., fiber optics) or unguided (e.g., free-space), follow a generic scheme. FIG. 1 presents a typical optical communications scheme 100 with an optical transmitter (Tx) that directs light through a channel 105, and the output light is collected by an optical receiver (Rx) 108. The transmitter 102 and receiver 108, and additional electrical and optical hardware and elements (not shown), encode and decode information onto the light respectively. The robustness of the encoded information against perturbations in the channel 105 is a determining factor of successful transmission. For example, a simple communications scheme of on-off keying (OOK) or amplitude-shift keying (ASK) in which 1s and 0s are encoded in light carriers of nonzero intensity and zero intensity, respectively, would not be a successful scheme given a channel that attenuates the light intensity, as shown in FIG. 1. As shown, a 1 bit is provided to the transmitter 102. The 1 bit is represented by a single pulse of light with an amplitude above a threshold. In the provided example, the 1 bit loses amplitude as it is transmitted through the noisy channel 105, and the amplitude of the 1 bit is below the threshold at the receiver 108. The 1 bit is then received and interpreted as a 0 bit, and therefore, the information is incorrect, and/or lost during transmission of the information via the optical communications scheme 100. While the provided example uses light amplitude attenuation, noisy channels may provide noise or render signals useless via polarization noise or changes, speckle and other noise, signal-to-noise (SNR) ratio issues, pulse spreading, dispersion, etc.

In general, communication channels exhibit noise of various types that reduce signal reliability or efficacy, and can even render signals useless or result in faulty readings or information. As such, improvements to noise sources and reducing noise in light signals is desirable.

### SUMMARY

A system, method, and apparatus for providing scattering-immune optical communications using coherence rank are disclosed. The system, method, and apparatus include a novel optical encoder of information using partially coherent light by considering two degrees of freedom (DoFs) simultaneously such that it is robust and potentially impervious to unitary (e.g., lossless and reversible) transformations. As described herein, a unitary transformation, U, is considered to be a matrix where when multiplying itself by its Hermitian adjoint, U†, results in the identity matrix, I. When two binary DoFs such as polarization and space limited to two points, are jointly considered, the coherence of a particle, or particles, can be represented by a 4×4 coherence matrix. The rank of a matrix is the number of its nonzero eigenvalues. The four possible ranks of the 4×4 coherence matrix can be used as encoders, or symbols, of signals in optical communication schemes. These symbols constitute an alphabet of four symbols that cannot be interconverted under any unitary transformation. Therefore, if an optical field is prepared as a certain rank and then transmitted through a unitary channel, the output of the channel will always be of the same rank. Furthermore, the rank will be maintained when measured at any location within the channel. This fact enables signals to be robustly transmitted without the sender or receiver having any knowledge of the channel, unlike in adaptive optical communication techniques that generally require specific knowledge of the channel.

The disclosed optical communication system, apparatus, and method are configured to use a 4×4 coherence matrix with respect to two of light's physical DoFs. For examples illustrated herein, the two DoFs demonstrated, without limitation, are polarization and spatial DoFs. While illustrated with respect to polarization and spatial DoFs, other DoFs are envisioned such as wavelength, temporal pulse width, frequency, amplitude level, spin, phase, or additional properties or characteristics such as electric field, magnetic field or quadrature properties. The system, method, and apparatus may be applied to rank-1 fields, rank-2 fields, rank-3 fields, rank-4 fields or rank-n fields with n being an integer depending on the tensor rank of the field. Application of the methods to these fields demonstrates the invariance of rank-1, rank-2, rank-3, rank-4, or rank-n fields to unknown unitary channels.

The advantages discussed herein may be found in one, or some, and perhaps not all of the embodiments disclosed herein. Additional features and advantages are described herein, and will be apparent from the following Detailed Description and the figures.

In one embodiment, the present disclosure provides a method for performing rank based communications. The method includes encoding information onto a signal using at least two different degrees of freedom of the signal, the signal having an initial coherence matrix; transmitting the signal though a transmission channel; detecting the signal at a detector; determining a resultant coherence matrix from the detected signal; diagonalizing the resultant coherence matrix and generating a diagonalized matrix; and determining the encoded information from the diagonalized matrix.

In variations of the current embodiments, the degrees of freedom include one or more of physical degrees of freedom, electromagnetic degrees of freedom, electric degrees of freedom, magnetic degrees of freedom, spatial degrees of freedom, temporal degrees of freedom, a polarization, a spin, a wavelength, a frequency, an intensity, a phase or orbital momentum.

In continued variations of the current embodiment, the initial coherence matrix is a 4×4 coherence matrix. In more variations, the degrees of freedom include two degrees of freedom that are not interconvertible via a unitary transformation.

In additional variations of the current embodiment, the transmission channel comprises a medium that performs one or more unitary transformations on the initial coherence matrix to transform the initial coherence matrix into the resultant coherence matrix. In more variations, the transmission channel comprises a scattering medium, or a channel with nonunitary global losses (e.g., that energy is lost uniformly).

In continued variations of the current embodiment, the signal includes one or more of an optical signal, a photon, an electrical signal, a magnetic signal, a qubit, a particle, an electric field, or another signal or field capable of carrying information.

In more variations of the current embodiment, the encoded information includes a four symbol alphabet that cannot be interconverted under any unitary transformation. In further variations of the current embodiment, the encoded information includes a number of alphabet symbols equal to a rank of the initial coherence matrix, wherein the rank of the initial coherence matrix is equal to a number of non-zero eigenvalues of the initial coherence matrix. In any variations of the current embodiment, the degrees of freedom each comprises a binary degree of freedom.

In a second embodiment, the current disclosure provides a system for rank communication. The system includes an encoder configured to encode information onto a signal using at least two degrees of freedom of the signal to generate an encoded signal having an initial coherence matrix, the encoded information include one or more symbols of a code alphabet; a signal detector configured to detect the signal after the signal has been transmitted through a transmission channel; an analyzer configured to: determine a resultant coherence matrix from the detected signal, the resultant coherence matrix, diagonalize the resultant coherence matrix to generate a diagonalized matrix, and identify one or more symbols of the code alphabet from the diagonalized matrix.

In variations of the current embodiment, the encoder encodes the information onto two binary degrees of freedom simultaneously. In continued variations of the current embodiment, the initial coherence matrix has a rank value equal to the number of non-zero eigenvalues of the initial coherence matrix, and the code alphabet have a number of symbols equal to the rank of the initial coherence matrix.

In additional variations of the current embodiment, the encoder is configured to encode the information onto two degrees of freedom of the signal, and the initial coherence matrix is a 4×4 matrix with four possible ranks that are configured to be used as the symbols of the code alphabet.

In more variations of the current embodiment, the symbols constitute a code alphabet of four symbols that cannot be interconverted under any unitary transformation.

In various variations of the current embodiment, the signal comprises one or more of an optical signal, a photon, an electrical signal, a magnetic signal, a qubit, a particle, an electric field, or another signal or field capable of encoding information on, or capable of carrying information.

In additional variations of the current embodiment, the signal comprises an optical signal, and the encoder comprises one or more of waveplates, polarizers, spatial filters, amplitude modulators, or phase modulators.

In further variations of the current embodiment, the analyzer comprises one or more of a quarter waveplate, a half waveplate, a wave plate, a polarizing beam splitter, a polarizer, a spatial filter, a beam block, or a spectral filter.

In a third embodiment, the present disclosure provides a system for performing coherence rank communication, the system including: an analyzer configured to create a 4×4 coherence matrix using two binary degrees of freedom simultaneously from an optical signal detected via an optical detector configured to detect optical signals, the signals including information that represents a coherence of the two degrees of freedom of the signal, wherein a rank of a matrix is a number of its nonzero eigenvalues, and wherein four possible ranks of the 4×4 coherence matrix are configured to be used as encoders or symbols of signals in optical communication schemes.

In a fourth embodiment, the present disclosure provides a system for performing coherence rank communication, the system including: an encoder configured to encode information onto a signal using two binary degrees of freedom generating a signal with a 4×4 coherence matrix of the two binary degrees of freedom, wherein a rank of a matrix is a number of its nonzero eigenvalues, and wherein four possible ranks of the 4×4 coherence matrix are configured to be used as encoders or symbols of signals in optical communication schemes.

### BRIEF DESCRIPTION OF THE FIGURES

FIG. 1 provides a block diagram of a typical optical communication system with a noisy transmission channel resulting in a misread bit value.

FIG. 2A provides a block diagram of an optical system demonstrating the invariance of coherence rank upon unitary transformations.

FIGS. 2B1 and 2B2 provide plots of density matrices for the evolution of a rank-2 coherence matrix through a transmission channel.

FIG. 3A presents a diagram of an example of optical communication over a strongly scattering channel with optical logical bits mapped to linear polarization states 0→H and 1→V, with the channel scrambling the polarization state.

FIG. 3B presents a diagram of an example of optical logical bits mapped to coherent spatial modes with 0→a and 1→b, and a transmission channel that scrambles the spatial modes.

FIG. 3C provides a diagram of optical logical bits mapped either to pure linear polarization states as in FIG. 3A or to coherent spatial modes as in FIG. 3B, with the transmission channel scrambling both of the degrees of freedom (DoFs) and coupling the DoFs randomly to each other.

FIG. 4 provides Poincare spheres of the polarization of optical communication signals utilizing polarization as the DoF through scattering channels with an encoding scheme polarization, weak scattering channel polarization, and strong scattering channel polarization with corresponding polarization matrices.

FIG. 5A presents a rank-1 4×4 coherence matrix for an optical communications system through a scattering optical channel with encoded matrices, scattered matrices, and decoded matrices.

FIG. 5B presents a rank-2 4×4 coherence matrix for an optical communications system through a scattering optical channel with encoded matrices, scattered matrices, and decoded matrices.

FIG. 5C presents a rank-3 4×4 coherence matrix for an optical communications system through a scattering optical channel with encoded matrices, scattered matrices, and decoded matrices.

FIG. 5D presents a rank-4 4×4 coherence matrix for an optical communications system through a scattering optical channel with encoded matrices, scattered matrices, and decoded matrices.

FIG. 6A provides a plot of the diagonal of the coherence matrix G={λ₁, λ₂, λ₃, λ₄} in a reduced 3D space spanned by λ₁, λ₂, and λ₃, with λ₄=1−(λ₁+λ₂+λ₃).

FIG. 6B provides a plot of a magnified view of an irreducible volume shown in FIG. 6A.

FIG. 6C provides an exploded view of the volume illustrated in FIG. 6B.

FIG. 6D provides a plot of experimental data and measurements of a communications systems resulting in the detected signals in the volume illustrated in FIG. 6B for performing robust signal transmission through a scattering channel.

FIG. 7 provides a flow diagram of a method for performing rank-based scattering-immune communications as described herein.

FIG. 8A provides a block diagram of an optical communications system for performing rank based scattering immune communications.

FIG. 8B provides an example grey-scale image for demonstrating scattering robust communications transmission.

FIG. 8C provides a sample data stream of bits for transmitting the image of FIG. 8B.

FIG. 8D provides plots of resultant polarization angles represented by unit vectors and determined bits of transmitted signals via a first channel and a first encoding scheme.

FIG. 8E provides a crosstalk matrix of a signal, and reconstructed image from the signals of FIG. 8D.

FIG. 8F provides plots of resultant polarization angles represented by unit vectors and determined bits of transmitted signals via a first channel using a second encoding scheme.

FIG. 8G provides a resultant crosstalk matrix of a signal, and reconstructed image from the signals of FIG. 8F.

FIG. 9A provides a block diagram of an optical communications system for performing rank based scattering immune communications.

FIG. 9B provides an example grey-scale image for demonstrating scattering robust communications transmission.

FIG. 9C provides a sample data stream of bits for transmitting the image of FIG. 9B.

FIG. 9D provides plots of resultant polarization angles represented by unit vectors and determined bits of transmitted signals via a second channel and a second encoding scheme.

FIG. 9E provides a resultant crosstalk matrix of a signal, and reconstructed image from the signals of FIG. 9D.

FIG. 9F provides plots of resultant polarization angles represented by unit vectors and determined bits of transmitted signals via a second channel using a third encoding scheme.

FIG. 9G provides a resultant crosstalk matrix of a signal, and reconstructed image from the signals of FIG. 9F.

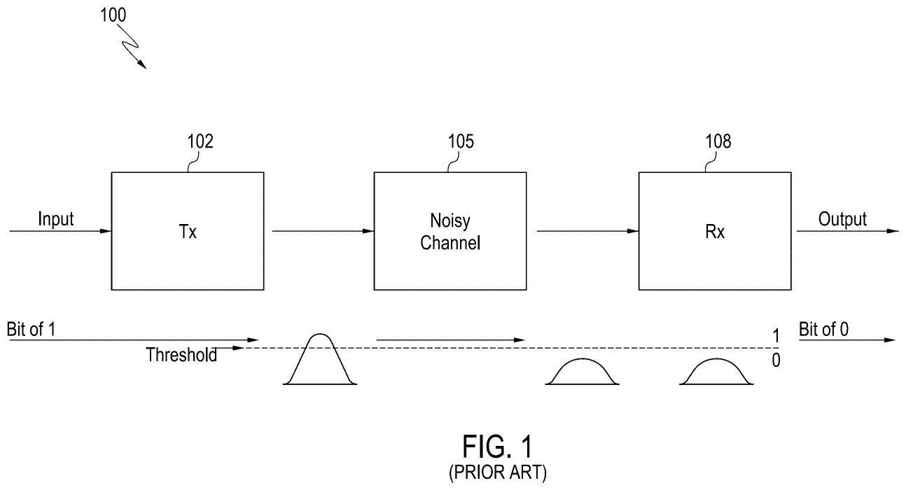

Similar numerals refer to similar parts throughout the specification.

### DETAILED DESCRIPTION

In optical communications, logical bits are encoded in degrees-of-freedom (DoFs) of the electromagnetic field. Example DoFs include field intensity, field amplitude, polarization, phase, temporal bin, wavelength, pulse width, etc. Consequently, optical scattering and other sources of noise in communications channels compromise optically encoded information during transmission. In worst-case-scenarios, bit-to-bit stochastically varying scattering that couples the DoFs to each other—including even unused DoFs—can decouple the transmitter and receiver when relying on conventional physical encoding schemes. This can reduce the efficiency and accuracy of adaptive techniques as a counter-measure. As disclosed herein, partially coherent optical fields are implemented in an optical communications system to generate a communications channel that is robust against rapidly varying, strong optical scattering, even when the channel is rendered not suitable for conventional communications, and optical communications implementations.

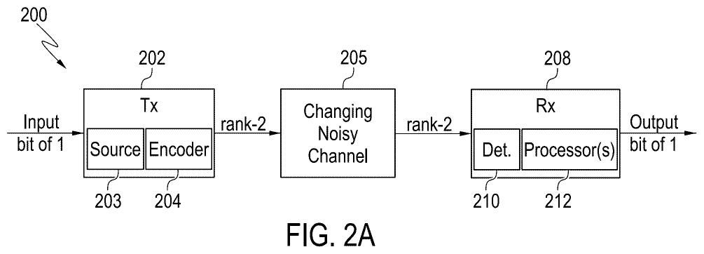

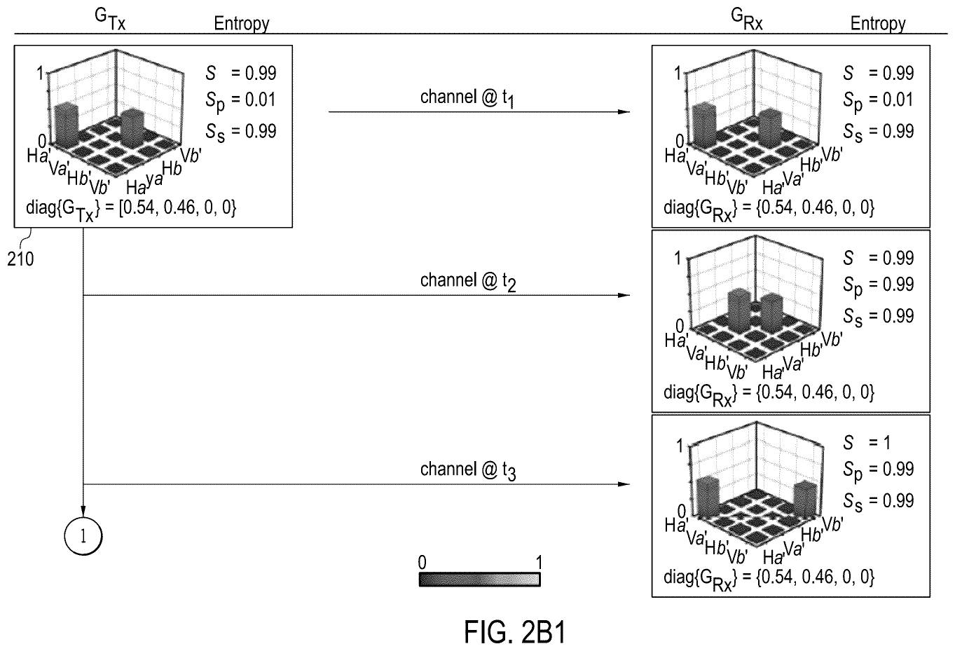

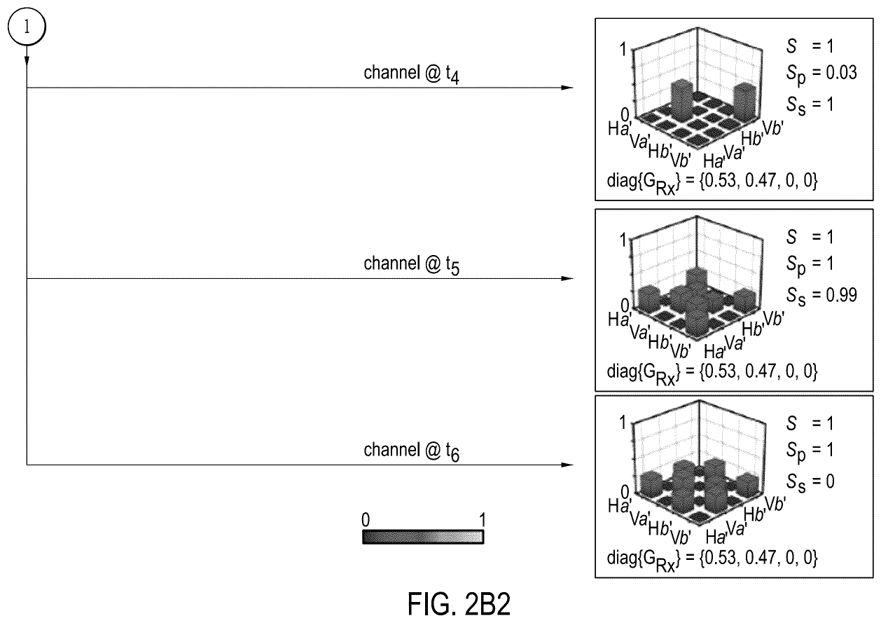

FIG. 2A provides an example optical system 200 for performing scattering-immune optical communication transmission as described herein. FIG. 2B is split into FIGS. 2B1 and 2B2 which provide population density plots of a signal at various points throughout the optical system 200. A transmitter 202 (Tx) receives a 1-bit and prepares a rank-2 optical field. The transmitter 202 includes a signal source 203 that generates a communications signal, and an encoder 204 that encodes information onto the signal. The signal source 203 may be a source of an electrical signal, magnetic signal, optical signal, or another type of signal source for performing communications transmissions. The encoder 204 may include one or more circuits, optical elements, or other hardware to encode information onto a signal.

The system 200 further includes a transmission channel 205 that the signal propagates through and has noise and/or scattering imbued thereon causing transformations to a coherence matrix of degrees of freedom of the signal. A signal detector 210 of a receiver 208 detects the signal after transmission through the channel 205, and a processor 212 or analyzer determines a resultant coherence field of the degrees of freedom of the signal. Information is then decoded using the resultant coherence matrix.

In provided examples, further described herein, the rank-2 optical field is measured and represented by the coherence matrix G_{Tx} shown in FIG. 2B. The rank-2 field is spatially incoherent and horizontally polarized, which can be understood by examining G_{Tx} and the associated entropy values. The field is directed through a channel 205 that is variant with time (t) randomly in amount of scattering of the field, and coupling of states of the field The channel converts the initially generated rank-2 field described by G_{Tx} to one described by G_{Rx}, which depends on the types of noise, attenuations, materials, length, electromagnetic properties, etc. of the channel 205. The coherence of the field changes depending on properties and materials of the channel, and the resulting matrix G_{Rx} varies notably with time. Additionally, the entropy values associated with each DoF are subject to change. However, regardless of the state of the channel, the number of nonzero eigenvalues in the diagonal of G_{Rx} (i.e., diag{G}) remains the same. Thus, the rank and the total entropy of the field is maintained and the encoded bit can be successfully decoded at the receiver side. As such, the demonstrated systems and methods allow for transmission of optical systems that utilize rank-2 fields with two DoFs that are immune to, or notably more robust to, noise in transmission channels as compared to traditional and current optical communications systems. While demonstrated herein using rank-2 fields, it should be understood that the described systems and methods may be applied to rank-1 systems, rank-3, systems, rank-4 systems, and other systems with rank-n depending on the degrees of freedom and tensor of the system.

A rank-2 field is prepared at Tx, then measured and represented by the coherence matrix G_{Tx}. This field passes through a channel that is variant with time (t), and so the various times represent different configurations of the channel. The channel converts the initial field to one with coherence described by G_{Rx}. The total entropy of the field S, the entropy of the polarization DoF Sₚ, and the entropy of the spatial DoF Sₛ are shown. The number of nonzero eigenvalues in diag{G} determines the rank. Here H and V are the horizontal and vertical polarization modes, and a and b are two spatial points separated in the transverse plane.

The disclosed system encodes logical bits in a unitarily invariant coherence rank, with coherence rank used herein to mean the number of non-zero eigenvalues of a field coherence matrix. The system disclosed herein demonstrates scattering-immune optical communications by exploiting maximum-entropy partially coherent fields of different rank. These results unveil an unexpected utility for partially coherent light in optical communications systems through challenging and noisy transmission environments.

Whether for communications or computation, information must be encoded in physical states, which is typically susceptible to information corruption in a channel that varies randomly in time and can contribute noise to the signals. Typically, logical bits are encoded in orthogonal physical states to optimize their distinguishability after traversing a communications channel that adds noise and introduces scattering. In optical examples, these physical states may include orthogonal polarization states or orthogonal spatial modes, and a scattering channel (e.g., a multimode optical fiber) randomly couples these physical states (e.g., the fiber modes). A variety of strategies have been explored to combat such scattering. Adaptive techniques assume the channel variations occur at a slower rate than the transmitted data stream, so that infrequent channel probing helps provide feedback to the encoding process. Such solutions are not viable when the noise, or signal corruption due to transmission channel changes bit-to-bit. Another strategy embeds the logical space in a subspace of a larger-dimensional physical space, which is dynamically decoupled from the environment, thereby mitigating channel-induced errors which has been developed for error correction in quantum communications and computation. This approach requires significantly larger physical resources, and may not be useful in strongly scattering environments or rapidly varying channels.

The current methods and system utilize partially coherent light to provide more robust optical signals to noise and scattering. Systems that apply partially coherent light typically rely on physical characteristics such as measurements of the coherence time, coherence width, or speckle statistics. However, partially coherent optical fields possess more free parameters than coherent-fields of the same dimensionality. A coherent field in a physical space spanned by N modes requires 2N−2 real parameters for its determination (e.g., growing linearly with N), while a partially coherent counterpart in the same space requires N²−1 (e.g., growing quadratically with N). As such, the synthesis and analysis of partially coherent fields requires more effort, but may offer a potential enhancement in information-carrying capacity of signals.

Another feature of optical communications channels is that they rarely deleteriously impact only a single DoF of the field. Rather, optical scattering in general couples multiple DoFs, whether used or unused in encoding the information, which further corrupts the transmission. For concreteness, described herein are optical channels in which the spatial and polarization DoFs are utilized for transmitting information. When a spatial DoF comprises two modes (e.g., spatial and polarization) the most general coherence matrix G associated with the polarization and spatial DoFs has a dimension of 4×4. Described herein, this class of coherence matrix is examined and the limits of entropy transfer between the two DoFs under global unitary transformations spanning both DoFs, also referred to as ‘unitaries’ herein, are determined. It is determined that the ‘coherence rank’ of the field, e.g. the number of non-zero eigenvalues of G, serves as a convenient classifier for categorizing partially coherent fields with respect to their behavior and transformation under unitaries.

Scattering channels are considered herein that represent example worst-case-scenarios for optical communications. The scenarios described and analyzed are: the transmission channel strongly scatters both the polarization and spatial DoFs so that using either DoF for communications fails; the channel scattering couples the two DoFs resulting in spatially dependent polarization changes or polarization-dependent spatial changes; and the channel changes unpredictably from bit to bit with no long-range correlation.

Herein it is shown that it is possible to devise physical states of an optical field that are immune to rapidly varying, strongly scattering channels, and thus, a reliably error-free optical communications system is demonstrated using partially coherent light. Herin, it is shown that partially coherent optical states of a dual-DoF field (e.g., polarization and spatial DoFs) can be constructed to transmit information that is immune to worst-case-scenarios of optical scattering in a communications channel. It is experimentally shown herein that scattering in the scattering communications channel is sufficient to fully scramble transmission when information is encoded in a single DoF. The single DoF used to demonstrate this is polarization. Provided herein are further experiments and results demonstrating that encoding logical bits in a coherence rank of the field encompassing both polarization and spatial DoFs is immune, or at least extremely robust, to intra-DoF (e.g., noise on a single DoF) and inter-DoF (e.g., cross talk and noise transfer between DoFs) scattering. The coherence rank is thus a stable structural field parameter by virtue of its invariance under any unitary transformation coupling the two example DoFs, in addition to global losses impacting the DoFs. Partially coherent two-point vector fields of different rank are constructed, and the field is transmitted through strongly scattering model channels that vary erratically from bit to bit. The fields are constructed by encoding the logical bits in the maximum-entropy field configuration associated with each rank. At the transmission channel output, tomographical reconstructions of the coherence matrix are generated from projective measurements, the eigenvalues are extracted, and coherence rank is determined, from which the immunity of the rank to strong scattering is confirmed. The provided methods and systems may be useful in establishing effective optical communications through challenging and noisy environments, and further be implemented in sensing and imaging systems through turbid media.

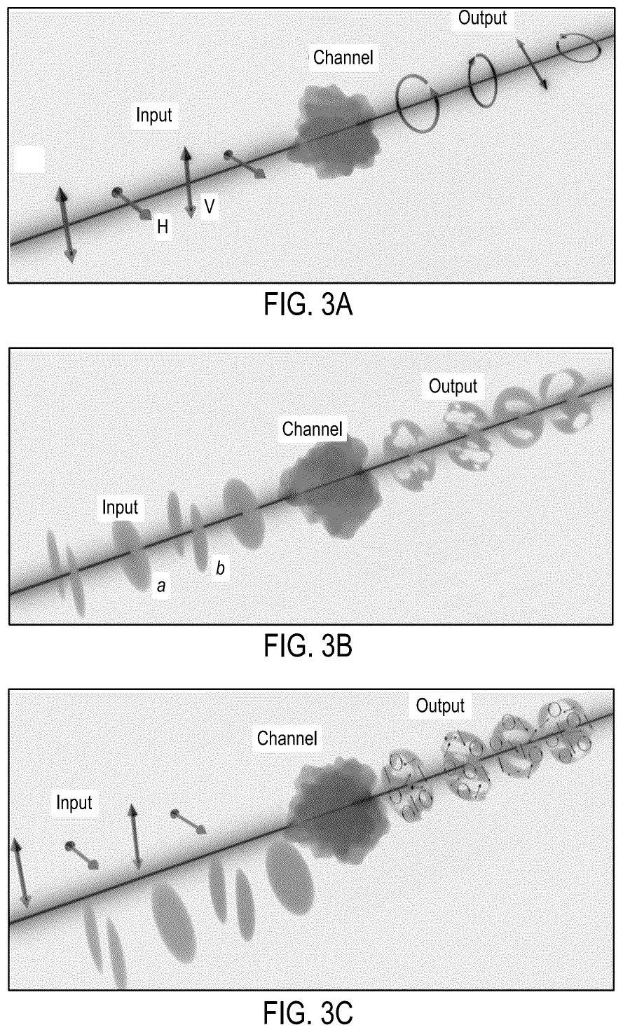

First, a conventional scenario of encoding information in a single DoF of the field is described. The scenario uses a single binary optical DoF, such as polarization, that is separable from the other DoFs. FIG. 3A provides an image showing input polarized bits of 0 and 1 encoded in two polarization states (E.g., horizontal and vertical polarization). The 0 and 1 states are represented by 2×2 polarization coherence matrices G₀ and G₁, respectively, which are Hermitian, unity-trace, and positive semi-definite,

$${G}_{p} = ( \begin{matrix}{G}^{HH} & {G}^{HV} \\ {G}^{VH} & {G}^{VV}\end{matrix} ) ,$$

where G^{jk}= [symbol] E^{j}E^{K*} [symbol] , E^{j} is a scalar component of the electric field of the signal, j and k correspond to either the horizontal H, or vertical V linear polarization states with respect to a fixed direction, and [symbol] · [symbol] is an ensemble average.

The following is assumed about the transmission channel for the single DoF scenario: (1) scattering and noise of the transmission channel impacts only the polarization DoF; (2) losses in the channel are not polarization-sensitive; (3) the channel is reversible and can be represented after factoring out losses by a unitary transformation Ûₚ; (4) Ûₚ is selected randomly and uniformly from the complete set of possible unitary transformations (e.g., with strong scattering); (5) Ûₚ changes bit-to-bit in time; and (6) Ûₚ at time t is statistically uncorrelated with Ûₚ at any other. This is an extreme model, and most realistic channels relax assumptions (4) through (6): the channel typically changes at a slower rate than the data, and Ûₚ is not selected uniformly from the set of all transformations (weak scattering). Working under such extreme assumptions highlights the unique advantage of coherence-rank communications and how robust the disclosed methods are to channel noise and scattering. FIG. 3B provides an image showing input bits of 0 and 1 encoded in two spatial modes, a first order spatial mode a and a second order spatial mode b. The orthogonal spatial modes may be described by

$${G}_{s} = ( \begin{matrix}{G}_{aa} & {G}_{ab} \\ {G}_{ba} & {G}_{bb}\end{matrix} ) ,$$

the 2×2 spatial coherence matrix in analogy with Gₚ, with a and b identifying two spatial modes instead of the polarization modes of FIG. 3A.

FIG. 3C provides an image showing input bits of 00, 01, 10, and 11 encoded in two polarization states (e.g., horizontal and vertical polarization), and two spatial modes a and b. The resultant 4×4 coherence matrix

$${G}_{ps} = ( \begin{matrix}{G}_{aa}^{HH} & {G}_{aa}^{HV} & {G}_{ab}^{HH} & {G}_{ab}^{HV} \\ {G}_{aa}^{VH} & {G}_{aa}^{VV} & {G}_{ab}^{VH} & {G}_{ab}^{VV} \\ {G}_{ba}^{HH} & {G}_{ba}^{HV} & {G}_{bb}^{HH} & {G}_{bb}^{HV} \\ {G}_{ba}^{VH} & {G}_{ba}^{VV} & {G}_{bb}^{VH} & {G}_{bb}^{VV}\end{matrix} ) ,$$

with H and V identifying two orthogonal polarization modes and a and b identifying two spatial modes. As such, the coherence matrix can be of rank-1, -2, -3, or -4, these cases will be further described herein for demonstrating the disclosed methods.

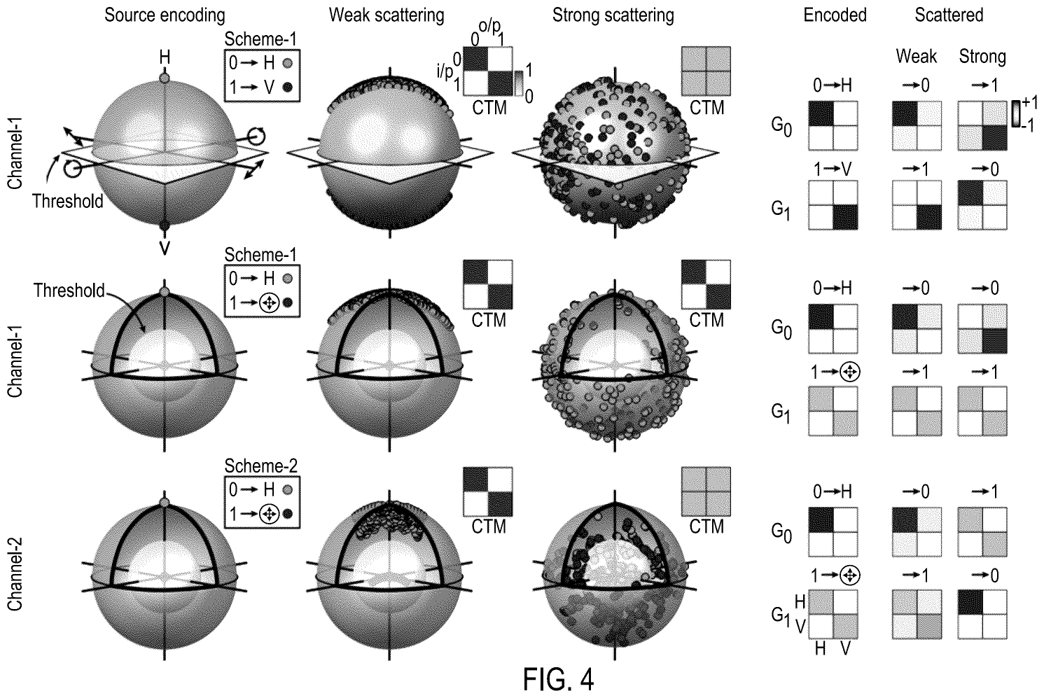

Typical encoding schemes map bits 0 and 1 to orthogonal polarization states, for example H and V as shown in FIG. 3A. The two modes correspond to two poles of a unity-radius Poincare sphere (PS). FIG. 4 provides multiple PSs showing the pure encoded states in the first column of the sphere with points at the north pole for a horizontal state and 0 bit, or the pure vertical state at the south pole as a 1 bit. The second column of FIG. 4 provide PSs resulting from transmission through weak scattering channels, and the third column shows PSs for transmission of signals through strong scattering channels. The further right columns of FIG. 4 provide polarization coherence matrix diagrams for the original encoded, weak, and strong scattering signals.

In the PS space,

$${G}_{0} = ( \begin{matrix}1 & 0 \\ 0 & 0\end{matrix} ) and {G}_{1} = ( \begin{matrix}0 & 0 \\ 0 & 1\end{matrix} ) ,$$

and the decision threshold for distinguishing between a 0 and a 1 bit is set at the equator plane of the PS with a 0 being above the equator, and a 1 being below the equator. This encoding scheme is susceptible to a scattering channel Ûₚ that scatters the polarization components and moves the point representing the field on the PS surface resulting in noisy transmitted signals or misread bits. For weak scattering, the points corresponding to G₀ and G₁ migrate away from the PS poles (e.g., away from pure 1 and pure 0states), but rarely cross the equator. The cross-talk matrix representing the coupling between the input and output logical states is diagonal, as required for a low bit-error-rate (BER). In presence of strong scattering, the G₀ and G₁ are equally likely after transmission of the signal through the channel to migrate to any position on the PS, and the cross-talk matrix is consequently flat with the transmitter and receiver being effectively decoupled with a BER˜50%.

In the provided examples, the scattered coherence matrices on the right side of FIG. 4, starting from the coherence matrices G₀ and G₁, or weak scattering results in coherence matrices that still resemble the encoding coherence matrices and can thus be successfully decoded. In contrast, for strong scattering, the example shown in FIG. 4 shows that the channel essentially swaps the polarizations of H and V, thus eliminating any chance of correctly decoding a signal. If the scattering channel does indeed change rapidly, then adaptive optics techniques are precluded as a remedy for any such optical communications system.

The impact of such severe scattering may be avoided by employing a different encoding strategy that maps 0 to pure H polarization (e.g., the PS north pole),

$${G}_{0} = ( \begin{matrix}1 & 0 \\ 0 & 0\end{matrix} ) ,$$

but maps 1 an unpolarized light, at the PS center,

$${G}_{1} = 1 / 2 ( \begin{matrix}1 & 0 \\ 0 & 1\end{matrix} ) ,$$

as shown in the second row of sets of matrices of FIG. 4. The two fields differ in the degree of polarization P, which corresponds to the distance from the PS center to the point on the PS representing the field. The degree of polarization for each is defined as P=|λ₁−λ₂|, where λ₁ and λ₂ are the eigenvalues of Gₚ; P=1 for G₀ and P=0 for G₁. The strongly scattering channel considered does not change P, so the decision threshold is set at the spherical surface P=½, as shown by the inner sphere in the second row of PSs of FIG. 4. Weak scattering results in G₀ migrating on the PS surface in the vicinity of the north pole, and strong scattering spreads the migration across the entire PS surface. Nevertheless, because G₁ is unaffected by either scattering regimes, the decision threshold at P=½ distinguishes G₀ and G₁. The cross-talk matrix is then diagonal even in the presence of weak or strong scattering. The furthest right column of matrices in FIG. 4 shows that the eigenvalues of G₀ and G₁ can be recovered to determine P in the strong scattering regime. Moreover, any point on the PS surface would be interpreted as a 0 bit. This encoding scheme is thus impervious to the extreme channel model adopted here for demonstrations of the described methods. Such a scheme is not implemented in current communications systems.

Described herein are examples of the efficacy of partially coherent light that provides improved communications system, and signal transmission, performance through noisy or scattering channel. The analysis is performed through the initial state matrices, transmission transformations due to channels and noisy mediums, and resulting received states for determining information. The parameters involved in defining Gₚ may be divided heuristically into ‘radial’ parameters that determine the radius from the PS center of a spherical surface on which the point representing the field lies, which is determined by the eigenvalues of Gₚ, and ‘angular’ parameters that determine the position of the point on the PS spherical surface. The scattering channel impacts the angular parameters, whereas the radial parameters are invariant. Coherent polarized optical fields, which lie on the PS outer surface, are dependent on the angular parameters and are affected by scattering. Therefore, relying on the radial parameter associated with the degree of polarization P to encode and differentiate bits 0 and 1, renders the communications scheme independent of Ûₚ, the unitary transformations of the transmission channel, noise, and scattering. In such a scheme, the angular parameters are not used in encoding or determining bit information. Rather than exploit the additional real parameters to identify the coherence matrix which increases the information-carrying capacity of a signal, as performed in many optical communications systems, the disclosed methods sacrifice extra parameters to create the more robust scattering resistant, or scattering immune, communications and signal transmission systems described herein.

However, this encoding scheme is not immune to de-polarizing channels that change the polarization P. The third row of PSs shown in FIG. 4 illustrates such a scenario. Such a transmission channel may cause entire changes in the polarization when the scattering channel couples signal polarization to an unused DoF, such as the spatial DoF. In performing the analysis of transmission in such a channel, the same assumptions were taken as above for the other described transmission channels and the unitary operations, with the added stipulation that the channel, represented by a 4×4 unitary transformation Û, couples the polarization and spatial DoFs arbitrarily bit-to-bit. Despite the unitarity of Û, P is no longer invariant through such a transmission channel. The channel may reduce P potentially resulting in the conversion G₀→G₁ or increase P resulting in the conversion G₁→G₀. Although the total entropy is invariant, entropy can be exchanged between the DoFs, thereby rendering a polarized field unpolarized, or an unpolarized field polarized (i.e., G₀↔G₁).

To describe this scenario, the description of the field is extended to a 4×4 coherence matrix G that encompasses both DoFs (e.g., polarization and spatial DoFs). The field is initially assumed to be in a separable state, G=Gₚ⊗Gₛ. The information is encoded in the polarization DoF, and the detector reconstructs only the reduced polarization coherence matrix Gₚ^{red.} after tracing out the unused spatial DoF. Without coupled DoFs, Gₚ^{red.}=Gₚ, resulting in the scenario illustrated in the middle row of FIG. 4. However, when the channel couples the DoFs, then Gₚ^{red.}≠Gₚ as shown in the bottom row of FIG. 4. If the channel causes both polarization and spatial scattering (e.g., intra-DoF scattering), and couples the polarization and spatial DoFs (e.g., inter-DoF scattering), then the point representing any input polarization state moves around the entire PS volume after traversing such a channel. Although the decision threshold at P=½ can distinguish G₀ and G₁ in the presence of weak scattering (e.g., a diagonal cross-talk matrix), the two points corresponding to G₀ and G₁ spread across the entire PS volume in presence of strong scattering, and thus cannot be distinguished by the decision threshold at P=½ (e.g., the flat cross-talk matrix). The described physical-channel models of FIG. 4 represent potentially worst-case scenarios from the point of view of polarization scattering. Communications across such channels may therefore not be viable due to bits being transformed during transmission into polarities of opposite bits.

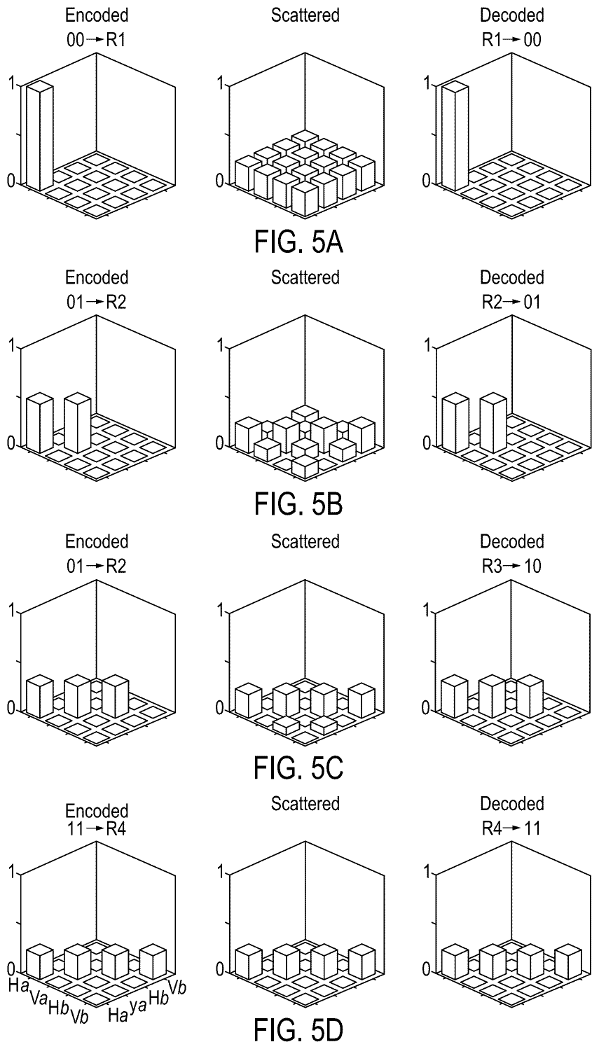

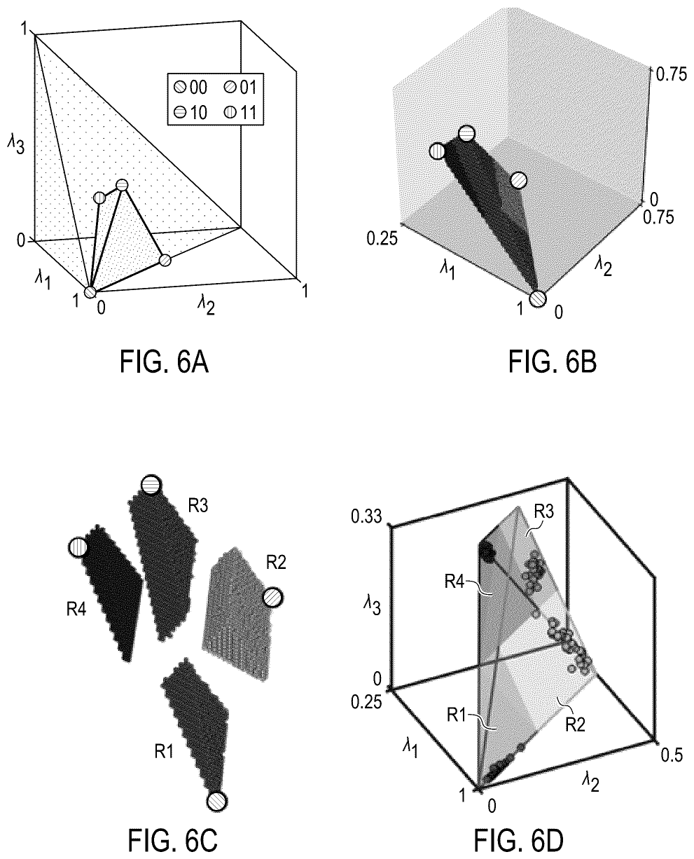

As described herein, the disclosed systems and methods are robust to these errors and allow for transmission through and accurate detection of bits through such noisy and scattering transmission channels. Coherence matrices, G, and resulting 3D representations will be discussed with reference to FIGS. 5A-5D, and FIGS. 6A-6D. FIGS. 5A-5D respectively provide graphs of a rank-1 field R1 representing bits 00, a rank-2 field R2 representing bits 01, a rank-3 field R3 representing bits 10, and a rank-4 field R4 representing bits 11. The left column in each of FIGS. 5A-5D shows the multi-DoF coherence matrices, the middle column shows an example instance of the coherence matrices after scattering in a channel by a unitary transformation as described herein, and the right column provides coherence matrices resulting from the diagonalization of the matrices in the middle column. For each rank, the coherence matrix presented corresponds to a maximum-entropy field. The maximum-entropy rank-4 field is the identify matrix, which is invariant under any unitary transformation. All the matrices presented in FIGS. 5A-5D are the real parts of G.

FIG. 6A provides plots of the diagonal of the coherence matrix G={λ₁, λ₂, λ₃, λ₄} in a reduced 3D space spanned by λ₁, λ₂, and λ₃, with λ₄=1−(λ₁+λ₂+λ₃). The various volumes illustrated in FIG. 6A corresponds to the projected space of all diagonalized coherence matrices. The smaller identified volumes correspond to coherence matrices with eigenvalues arranged with descending values λ₁≥λ₂≥λ₃≥λ₄. The provided legend identifies the 2-bit encoding schemes in which the bits are associated with the states at the vertices of the sub-volumes shown, which corresponds to the maximum entropy fields for each rank. FIG. 6B provides a plot of a magnified view of an irreducible volume shown in FIG. 6A. FIG. 6C provides an exploded view of the volume illustrated in FIG. 6B. The different surfaces separating the sub-volumes in FIG. 6C represent the decision thresholds for the logical alphabet (e.g., 00, 01, 10, 11). FIG. 6D provides a plot of experimental data and measurements of a communications systems resulting in the detected signals in the volume illustrated in FIG. 6B for performing robust signal transmission through a scattering channel.

Utilizing partially coherent fields in the full space encompassing both DoFs can overcome the issue of corrupted bits due to a noisy or scattering transmission medium. By exploiting both DoFs, pairs of bits are encoded in the rank of G. Any point on the generalized PS for two binary DoFs is determined by 16 real parameters: 12 ‘angular’ parameters, and 4 ‘radial’ parameters corresponding to the eigenvalues of G after diagonalization, whereupon G=diag{λ₁, λ₂, λ₃, λ₄}, where λⱼ are the non-negative eigenvalues of G,

$${\sum }_{j = 1}^{4} {λ}_{j} = 1 ,$$

and all off-diagonal elements are set to zero. Diagonalization eliminates all the angular parameters and retains only the radial parameters. For a single binary DoF, there are two radial parameters, the eigenvalues λ₁ and λ₂, which are reduced to one after normalizing the trace. For two binary DoFs, there are 4 radial parameters, which are reduced to 3 after normalization.

Whereas R1 fields are uniquely defined by the coherence matrix G=diag{1,0,0,0} in the diagonal representation, as shown in FIG. 5A, fields of higher rank afford broad flexibility in selecting a representative member associated with the rank. For example, R2 fields G=diag{λ₁,λ₂,0,0} with λ₁+λ₂=1 is a one-parameter family of fields that have the same rank but differ in entropy S=−λ₁ log₂ λ₁−λ₂ log₂ λ₂, as shown in FIG. 5B. The flexibility provided by the R2 fields extends to two-and three-parameter families of fields for R3 and R4, illustrated in FIGS. 5C and 5D respectively. To demonstrate the scattering immune communications described herein, the following encoding scheme was selected as an example: 00→R1, 01→R2, 10→R3, and 11→R4,with RI refers to rank-1 fields, R2 to rank-2 fields, etc.

Restricting the PS to a 4D space spanned by {λ₁, λ₂, λ₃, λ₄}, each G corresponds to a point on a plane embedded in that space. Projecting such a 4D plane onto a restricted 3D space spanned by {λ₁, λ₂, λ₃} results in a pyramid volume. When ordering the eigenvalues in descending order (λ1≥λ2≥λ3≥λ4), the volume is reduced to that shown in FIGS. 6A and 6B.

The coherence matrix corresponding to the maximum entropy for each rank was used: for R1 G=diag{1,0,0,0} (S=0), for R2 G=(1/2)diag{1,1,0,0} (S=1 bit), for R3 G=(1/3) diag{1,1,1,0} (S≈1.585 bits), and for R4 G=(1/4)diag{1,1,1,1} (S=2 bits), illustrated in the leftmost columns of FIGS. 5A-5D. The angular parameters of the coherence matrices are affected by scattering, shown in the middle column of FIGS. 5A-5D, and the structure of the coherence matrix can change significantly. Nevertheless, the radial parameters (e.g., the eigenvalues of G) can be recovered by diagonalization, even in the presence of inter-DoF scattering, to decode the rank, as shown in the right column of FIGS. 5A-5D.

The particular fields chosen correspond to the vertices of the reduced volume illustrated in FIGS. 5A and 5B. The volume was reduced by taking a Euclidean metric in the space of the eigenvalues. The reduced volume was subdivided into segments corresponding to states of the optical fields that are ‘closest’ to each of the vertices as illustrated by the independent sub-volumes in FIGS. 6B and 6C. The surfaces separating the sub-divided segments represent the decision thresholds at the detector for determining which bits were transmitted from the alphabet (e.g., 00,01, 10, or 11). The depolarizing transmission channel in the strong scattering regime corresponding to the third column of FIG. 4 (third column) has no impact on the selected vertices so that the resulting 4×4 cross-talk matrix is diagonal. Coherence-rank communications is thus viable even through such an example worst-case-scenario transmission channel with no need to resort to adaptive techniques or other error corrective or signal corrective approaches.

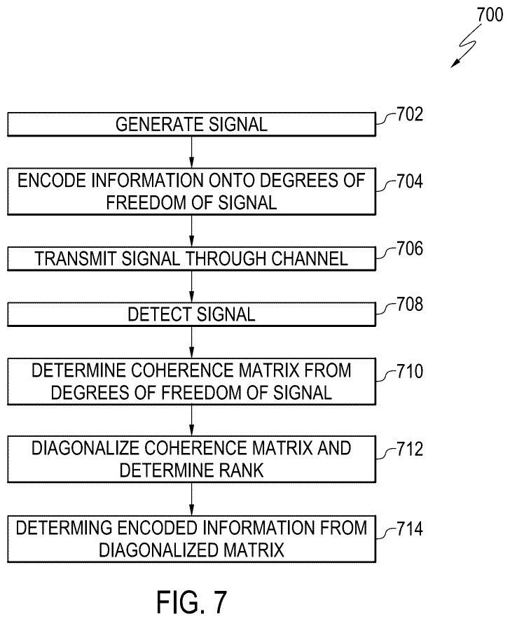

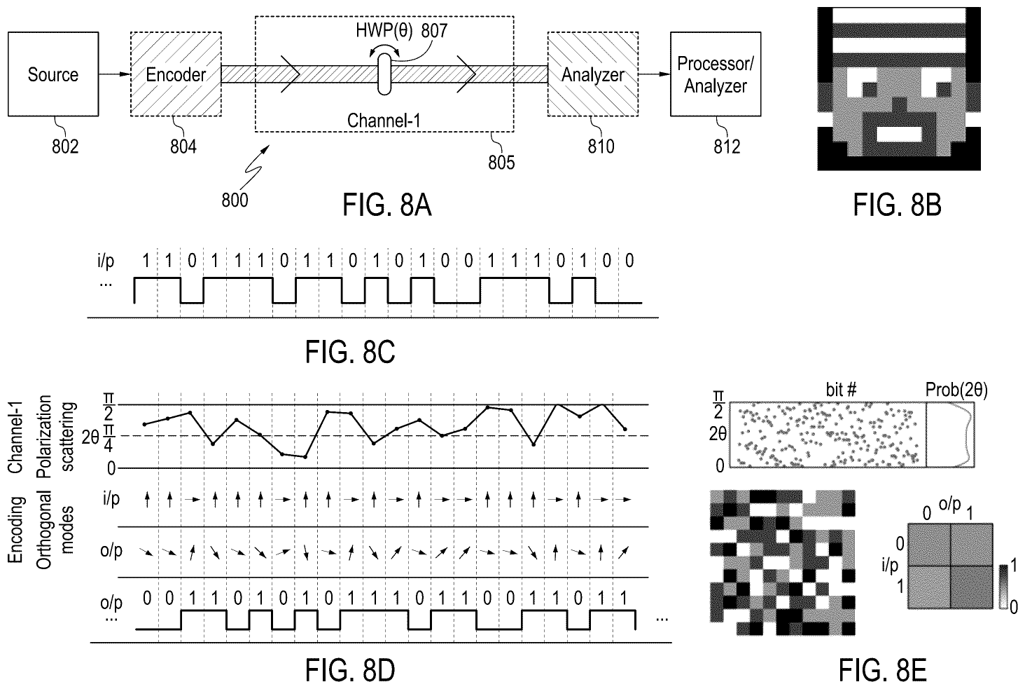

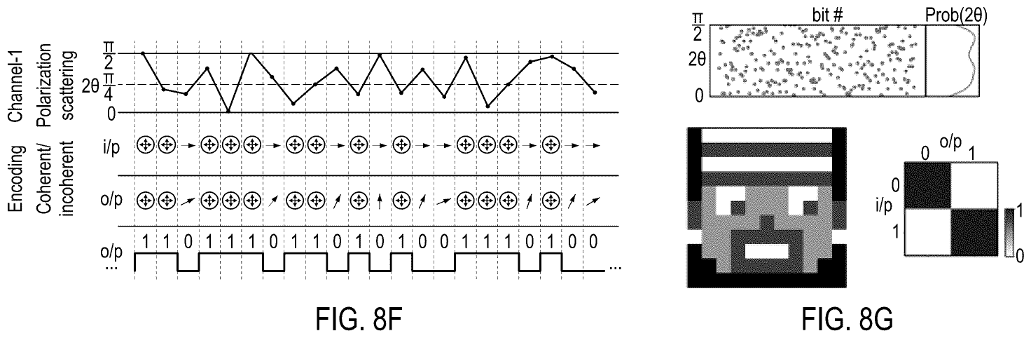

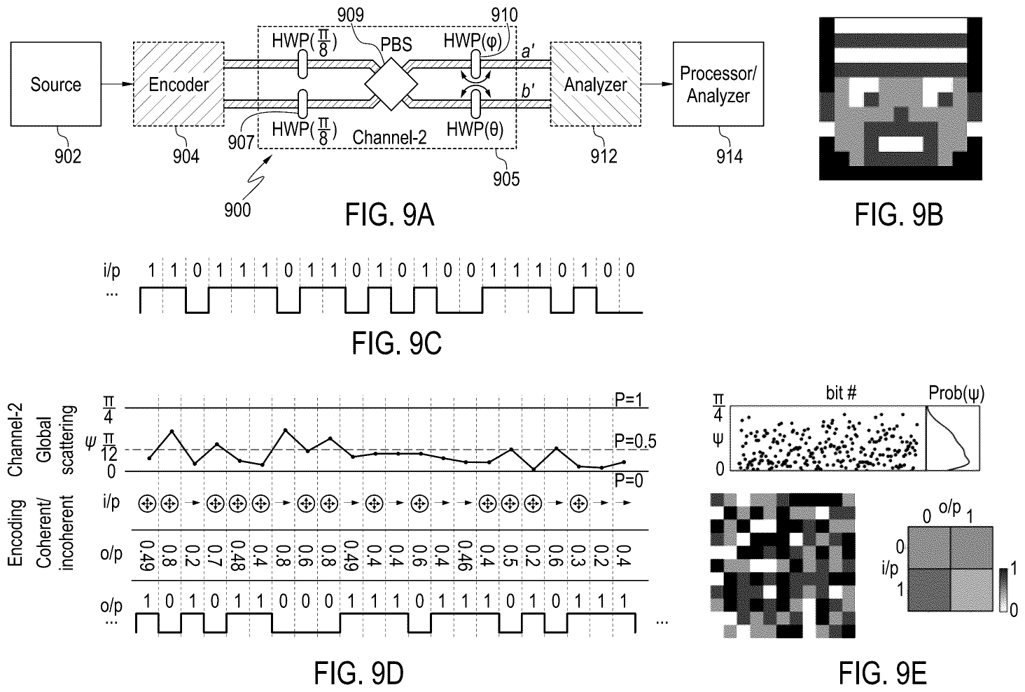

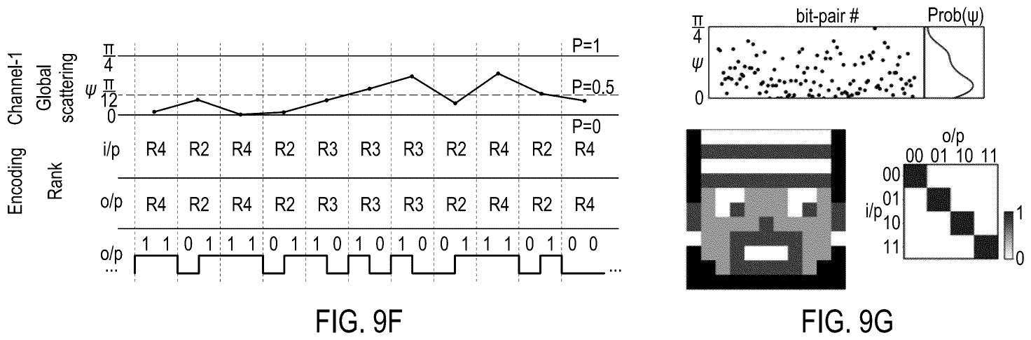

FIG. 7 provides a flow diagram of a method 700 for performing rank-based scattering-immune communications as described herein. The method 700 includes generating a signal (block 702). The signal may be an electrical signal, an optical signal, a magnetic signal, a particle, a qubit, an electric field, a magnetic field, or another signal or field capable of encoding information on, or capable of carrying information. The signal may be generated by one or more sources such as a laser, LED, voltage source, undulator, source of electrons, an electric field, a magnetic field, or another signal or field capable of encoding information on, or capable of carrying information. A signal source, such as the signal source 203 of FIG. 2, may provide the signal, or sources as described in reference to FIGS. 8 and 9.

An encoder, such as the encoder 204 of FIG. 2, or another encoder, encodes information onto the signal using at least two different DoFs of the signal (block 704). The encoder may encode the information on one or more physical, electric, magnetic, quantum, or other properties of the signal. In examples, the encoder may encode the information using one or more of physical degrees of freedom, electromagnetic degrees of freedom, electric degrees of freedom, magnetic degrees of freedom, spatial degrees of freedom, temporal degrees of freedom, a polarization, a spin, a wavelength, a frequency, an orbital angular momentum, an intensity, a phase, etc. The encoder may include various elements for encoding information onto the signal. For example, the encoder may include a frequency modulator, an amplitude modulator, a phase modulator, a waveplate, a beamsplitter, a frequency filter, a spatial filter, a waveform generator, a polarizer, an optical fiber, a pulse shaper, or another element to encode information to the optical signal. Additionally, the encoder may encode the information into a bit based encoding scheme, or a higher dimensional data space using the DoFs for the signal.

The encoder may encode information onto the signal, with the information represented by an alphabet with a number of symbols equal to the rank of a coherence matrix of the DoFs of the signal. For example, using two physical DoFs, such as polarization and spatial mode of an optical signal, the encoder encodes an alphabet of four symbols (e.g., 00, 01, 10, and 11) onto the signal via both the polarization and spatial mode DoFs. Utilizing two different DoFs such as polarization and spatial mode allow for four symbols that are not interconvertible under any unitary transformation. The described methods may be implemented using two binary DoFs such as binary polarization (e.g., polarized/unpolarized or vertical/horizontal polarization) and binary spatial mode (e.g., 1^{st} Hermitian mode and 2^{nd} Hermitian mode). In such examples, the resulting coherence matrix is 4×4 matrix (e.g. rank-4 due to the 4 non-zero eigenvalues of the matrix) with a 4 symbol alphabet corresponding to the rank of the coherence matrix. In further examples, the encoder may encode information using non-binary DoFs. For example, a first DoF may have a dimension of N₁, and a second DoF may have dimension N₂, resulting in a coherence matrix with dimensions (N₁×N₂)×(N₁×N₂). Sucha matrix then has N₁×N₂ eigenvalues and a symbol alphabet of N₁×N₂. Such an alphabet would be immune to scattering through noisy channels using the methods described herein. As such, the described methods allow for scalable communications based on the number of dimensions of each DoF used for encoding the information. Herein, the coherence matrix of the DoFs of the encoded signal may be referred to as the “initial coherence matrix,” being the coherence matrix of the signal before transmission of the signal through a channel or medium.

The method 700 further includes transmitting the signal though a transmission channel (block 706). The transmission channel may be a channel that imbues scattering or noise onto the signal. In examples, the transmission channel may include one or more of an electrical wire, an optical fiber, free-space, a turbid medium, waveguide, a transmission line, a vacuum, a medium with nonunitary global losses where energy is lost uniformly. The channel may transform the coherence matrix of the signal via one or more unitary transformations by intra-DoF (e.g., noise on a single DoF) and/or inter-DoF (e.g., cross talk and noise transfer between DoFs) scattering to transform the initial coherence matrix into a resultant coherence matrix of the signal.

A signal detector, such as the detector 210 of FIG. 2, or further detectors described in reference to FIGS. 8 and 9, then detects the signal after transmission through the channel (block 708). The signal detector may include one or more photodiodes, APDs, optical sensors, cameras, wavefront sensors, frequency analyzers, spectrum analyzers, biomimetic sensors, organic sensors, etc. The detector may include elements to specifically detect or determine the states of the DoFs of the signal. For example, the detector may include one or more waveplates, polarizers, spatial filters, etc. The method 700 further includes determining a resultant coherence matrix of the DoFs of the transmitted signal (block 710). The detector may provide the measured DoFs, or electrical signals indicative of the states of the DoFs to one or more processors, such as the processor(s) 212 of FIG. 2, or the processors/analyzers of FIGS. 8 and 9 discussed further herein, and the processor(s) may determine the resultant coherence matrix based on the states of the DoFs of the signal.

One or more processors then diagonalizes the resultant coherence matrix (block 712). The diagonalization results in non-zero elements of the matrix to be on the main diagonal of the matrix. The rank of the matrix is then identified from the number of non-zero values along the diagonal (e.g., the eigenvalues of the matrix). The encoded information is the decoded from the diagonalized matrix (block 714). In examples, the encoded information may be a symbol of an alphabet, and the specific symbol may be identified based on the rank of the matrix as determined using the diagonalized resultant coherence matrix. Using binary polarization and binary spatial modes to encode the information onto two DoFs, the encoded information (e.g., 00, 01, 10, or 11) may be identified or decoded by determining the rank of the 4×4 resultant coherence matrix. (e.g., rank-1 corresponding to 00, rank-2 corresponding to 01, rank-3 corresponding to 10, or rank-4 corresponding to 11).

The methods described herein were performed using two different optical communications setups. FIG. 8A provides a block diagram of an optical communications system 800. The system 800 includes an optical source 802 that generates optical signals and an encoder 804 further encodes information onto the signals on two different DoFs of the signal. In the provided examples the two DoFs are polarization and spatial mode of the optical field. In examples, the source may include lasers, LEDs, other light sources, electron sources, electrical signal generators, etc. The encoder 804 may include hardware for encoding the information onto a signal such as waveplates, wavelength filters, spatial modulations, arbitrary waveform generators, polarizers, amplitude modulators, phase modulators, etc. The system 800 further includes a transmission channel 805 that transmits the signal from the source 802 to a detector 810. The transmission channel 805 includes a waveplate 807. In the provided example, the waveplate 807 is a halfwave plate that is tunable to provide a polarization change or scattering to the optical signal. The halfwave plate is tunable to provide varied changes to the polarization of different bits of the data stream. The detector 810 may include one or more optical components (e.g., filters, polarizers etc.) and a photodetector to detect the optical signal. The additional optical hardware of the detector 810 may be used to perform optical operations on the signal for detecting specific properties of the signal, such as the DoFs on which the information is encoded. A processor or analyzer 812 may then receive information from the detector indicative of one or more degrees of freedom of the signal, and the processor/analyzer 812 may reconstruct a resultant coherence matrix, perform diagonalization of matrices, and decode information or bits from the diagonalized matrix.

FIG. 8B provides an example grey-scale image used to demonstrate the scattering robust communications described herein. An optical data stream corresponding to the image included 11×11 pixels and 4 gray-scale levels for each pixel resulting in a total of 242 bits of transmitted data. The data was encoded on an optical signal and transmitted through two model channels. FIG. 8C shows a sample data stream of the bits transmitted. The first channel, Ch-1, corresponds to an unknown polarization transformation in the strong scattering regime. The strong scattering regime was realized using the half-wave plate 807 rotated an angle θ with respect to a fixed axis of propagation, resulting in a transformation of

$$\hat{U} ( θ ) = [ \begin{matrix}cos 2 θ & sin 2 θ \\ sin 2 θ & - cos 2 θ\end{matrix} ] .$$

A worst-case-scenario was performed where θ changes randomly bit-to-bit with a probability density function for θ that is uniform over the span [0,45°], illustrated in the plots of FIG. 8D. The correlation length for θ is 1 bit. FIGS. 8D-8G present the results for two encoding schemes through Ch-1. In the first encoding scheme, shown in FIG. 8D, the data is encoded in linear polarization states, with 0→H and 1→V polarization encoding. The optical source 802 was an unpolarized LED that was spatially filtered. The polarization was selected via a linear polarizer with an orientation was appropriately switched according to the desired bit (e.g., 0 or 1). In each of the following measurements, the spatial profile of the modes was maintained using collimating lenses to reduce any propagation-induced coherence changes. The coherence matrix for the output field was reconstructed using optical coherence matrix tomography (OCmT).

The channel 805 transformed the polarization states H and V into new linearly polarized states, resulting in a measured BER ˜50% and a flat cross talk matrix, indicating equal coupling between any input and output states. FIG. 8E provides the reconstructed image from the data transmitted via Ch-1 using the H and V polarization encoding. The reconstructed image as generated by the analyzer 810 and one or more processors is corrupted as expected from such a strongly scattering channel. The original image is not discernable from the reconstructed image. In examples, the analyzer 810 may include one or more processors, optical components, circuits, and other elements for detecting and/or analyzing the signal and DoFs to determine the resultant coherence matrix.

In the second encoding scheme, the 0 and 1 bits were encoded on polarized and unpolarized states, 0→H (P=1) and 1→unpolarized light (P=0), respectively, to encode the same data stream as in the previous case, and traverse Ch-1. FIG. 8F provides the data stream and resultant signals of the bit stream encoded using polarized and unpolarized signals. The same spatially filtered unpolarized LED was used as the source 802, and a linear polarizer was used to produce polarized, or removed from the system to generate unpolarized light. Because P is invariant under these conditions, this encoding scheme is shown to be impervious to the scattering and noise of Ch-1 despite the randomizing HWP. FIG. 8G provides the reconstructed image from the received signals. The resulting cross-talk matrix was diagonal, as shown in FIG. 8G, and the image was fully reconstructed indicating that all data was successfully transmitted, without corruption, through the heavy scattering transmission channel 805.

In another implemented example of the disclosed methods and systems for scattering and noise robust communications, a second channel, Ch-2, introduces additional noise and scattering in both DoFs (e.g., polarization and spatial). FIG. 9A provides a block diagram of an optical communications system 900 for performing the disclosed methods and for demonstrating scattering immune communications. The system 900 includes an optical source 902 that generates optical signals and an encoder 904 further encodes information onto the signals on two different DoFs of the signal. In the provided examples the two DoFs are polarization and spatial mode of the optical field. In examples, the source may include lasers, LEDs, other light sources, electron sources, electrical signal generators, etc. The encoder 904 may include hardware for encoding the information onto a signal such as waveplates, wavelength filters, spatial modulations, arbitrary waveform generators, polarizers, amplitude modulators, phase modulators, etc. The system 900 further includes a transmission channel 905 that transmits the signal from the source 902 to a detector 912. The transmission channel 905 includes a plurality of waveplates 907. In the provided example, the waveplates 907 include waveplates at a fixed angle, a polarization beam splitter (PBS) couples the polarization and spatial DoFs 909, and waveplates with variable angles that can change bit-to-bit, independently 910. The detector 912 may include one or more optical components (e.g., filters, polarizers etc.) and a photodetector to detect the optical signal. The additional optical hardware of the detector 912 may be used to perform optical operations on the signal for detecting specific properties of the signal, such as the DoFs on which the information is encoded. A processor or analyzer 914 may then receive information from the detector indicative of one or more degrees of freedom of the signal, and the processor/analyzer 914 may reconstruct a resultant coherence matrix, perform diagonalization of matrices, and decode information or bits from the diagonalized matrix.

In the system 900 of FIG. 9A data and information was encoded on both the polarization and spatial DoFs in Ch-2. The spatial DoF comprises a pair of spatial modes identified as a and b, which correspond to two mutually incoherent points selected from an LED field as generated by the source 902. A variety of randomly varying effects occur in the transmission channel simultaneously, including, without limitation, the polarization of the signals is rotated, the spatial DoF is modified, and the polarization and spatial DoFs are coupled to each other.

The channel model of FIG. 9A was designed according to the disclosed methods to be rank-preserving for the full 4×4 DoF coherence space spanned by polarization and spatial modes. In Ch-2, polarized light at the input may become unpolarized through the transmission channel 905 and be unpolarized at the output, and unpolarized light may become polarized as a result of entropy swapping between the DoFs. Consequently, transmission Ch-2 disrupts examples of encoding scheme-1 and encoding scheme-2 that rely solely on the polarization DoF. Nevertheless, coherence-rank communications, referred to herein as encoding scheme-3, remains feasible because the rank in the full 4×4 space is preserved despite random entropy swapping between the two DoFs.

The impact of Ch-2 on encoding scheme-2 that was implemented in the system 800 of FIG. 8A was determined for the system 900 of FIG. 9A. The first measurements only utilized the polarization DoF with bit encoding 0→H and 1→unpolarized light. The same data stream used in the measurements provided in FIGS. 8A-8G was used. FIG. 9B provides a grey-scale image of the data transmitted for the following measurements and demonstrations. FIG. 9C provides a sample of data of the transmitted bit stream. The optical field was initially separable with respect to the two DoFs, G=Gₚ⊗Gₛ, and the spatial DoF comprised a single mode a (e.g., a spatially coherent field) after blocking the second mode b at the input using an opaque obstruction. Two HWP settings, denoted θ and φ, were varied randomly over independent, uniform probability distributions. FIG. 9D provides determined bit streams and a probability distribution of the absolute difference of the HWP angles ψ=|φ−θ|. After transmission through the channel, the polarization DoF was measured for the signals. Additionally, the trace was performed over the spatial DoF, which corresponds to the reduced coherence matrix

$${G}_{p}^{red .} = {Tr}_{s} \{ G \} .$$

Due to the fact that Ch-2 couples the two DoFs, the initially separable states (e.g., polarization and spatial states) become non-separable, and consequently

$${G}_{p}^{red .} \neq {G}_{p} .$$

For strong scattering,

$${G}_{p}^{red .}$$

is altogether decoupled from Gₚ, and the measured cross-talk matrix is flat in contrast to the outcome for the same encoding scheme in Ch-1 where the cross-talk matrix was diagonal. FIG. 9E presents the resultant flat matrix due to the non-separable detected coherence matrices, as compared to the diagonalized resultant coherence matrix of the same encoding scheme in FIG. 8G.

The second encoding scheme employed in Ch-2 used a coherence rank encoding scheme, scheme-3. FIG. 9F presents the coherence rank communications scheme that is robust to scattering in transmission channels, as described herein. For encoding scheme-3 pairs of bits of the data stream were encoded in partially coherent optical fields of different rank, making use of the maximum-entropy field representative of each rank in the diagonal matrix representation. The symbols of the encoding alphabet mapping pairs of bits to rank were 00→R1, 01→R2, 10→R3,and 11→R4. The points associated with the 4×4 coherence matrices generated at the source correspond to vertices of the highlighted, restricted sub-volume shown in FIGS. 6A and 6. A maximum likelihood estimation (MLE) technique was used in reconstructing the 4×4 coherence matrices G at the source and after Ch-2 to ensure that G satisfies the criteria for a coherence matrix. In particular, the MLE technique was used to exclude coherence matrices that violate positivity. Ch-2 substantially modifies G produced at the source by coupling the two DoFs to each other, thereby converting the representation of G from diagonal to non-diagonal. At the transmission channel output, the coherence matrix of the signal G was reconstructed tomographically via joint spatial-polarization Stokes-parameter measurements. The eigenvalues of G were then extracted and the rank of the coherence matrix G was then determined. Deviations of the point representing the resultant G from ideal points at the vertices of the restricted sub-volumes of FIGS. 6B and 6C were due to measurement errors at the receiver in reconstructing G that were unrelated to the randomly varying Ch-2.

The coherence matrix G for each received signal was determined and an associated sub-volume of the PS space was identified for each signal. A Euclidean metric in the {λ₁, λ₂, λ₃, λ₄}- space was used to determine which sub-volume segment each signal occupied. A plot of the measured G reconstructed at the Ch-2 output is presented in FIG. 6D. As shown in FIG. 6D the output points cluster around the vertices but do not cross the boundary surfaces between the sub-volume segments which correspond to the decision thresholds under a Euclidean metric. Consequently, the resultant measured 4×4 cross-talk matrix was diagonal and the image was successfully reconstructed. FIG. 9F provides plots of the determined bits from the transmitted data stream, and FIG. 9G provides the resultant diagonalized coherence matrix and reconstructed grey-scale image using encoding scheme-3 and the noise and scattering of Ch-2. As such, coherence-rank communications as shown with example encoding scheme-3 is shown to successfully, and error free, transmit data through worst-case scattering scenarios as provided by Ch-2.

In addition to the possibility of establishing scattering-immune optical communications in the presence of the worst-case-scenarios of scattering, coherence-rank communications offers further advantages. First, this scheme solves the problem of frame-sharing; that is, the sender and receiver need not share the same polarization axes for defining the physical states of the field. A polarization misalignment between the sender and receiver corresponds to an additional unknown unitary transformation, which does not affect the coherence rank. Indeed, the sender may choose to vary the polarization basis bit-to-bit without impacting the receiver's ability to decode the information. Similarly, phase offsets between the spatial or polarization modes that may be incurred in the communications channel do not impact the coherence rank. Although overall losses are non-unitary, they do not impact this scheme because they are rank-preserving. Modal-dependent losses are also rank-preserving, yet they may impact the described scheme by potentially moving G across the boundaries of the decision domains of a PS, thereby leading to communications errors.

The described rank based coherence communications methods may be implemented in various systems and environments. The general integrated-photonics approach known as ‘programmable photonics’ may be implemented with the described techniques utilizing coherent light to expand the usefulness of the disclosed methods to additional scenarios Furthermore, deep learning may be used to reduce the number of measurements required given a larger number of free parameters defining a coherence matrix G with respect to a coherent field. This suggests feasibility of high-speed optical communications with partially coherent light for rank-based scattering-immune communications.

For examples herein, the encoding of bits using polarization were shown. Other DoFs may be used to implement the disclosed methods. For example, a system may utilize a spatial DoF for optical communications. Such a scheme may be particularly beneficial in light of recent rapid advances in spatial-mode multiplexing in multimode optical fibers. Relying on partially coherent light may thus provide a solution for the hurdle resulting from modal scattering at fiber bends and imperfections, which may also couple the spatial DoF to polarization. Rather than using two orthogonal modes to encode the information, one may utilize coherent and incoherent spatial fields, which is immune to scattering among these modes. Second, the coherence-matrix formulation can be readily extended to larger-dimensional DoFs of the optical field (e.g., bigger encoding alphabets). For example, the DoFs may include spatial modes in a multimode optical fiber, laser lines in a frequency comb, or time-bin communications. In general, for two DoFs represented in spaces of dimensions N₁ and N₂, the associated coherence matrix has dimensions (N₁×N₂)×(N₁×N₂), with N₁×N₂ eigenvalues potentially offering independent communications channels of the resultant total number. Third, a variety of optical transmission ‘channels’ can be investigated besides multimode optical fibers, including biological samples, underwater optical communication channels, the turbulent atmosphere, and turbid media.

While examples herein utilize polarization and spatial modes as two DoFs for encoding information, other DoFs of a signal may be used. The specific DoFs used for performing the rank-based scattering immune communications described may depend on the types of signals for transmitting information, types of environments and conditions of the transmission channel, or another application specific requirement or condition

It should be appreciated that the systems, methods and procedures described herein may be implemented using one or more computer programs or components. The programs of the components may be provided as a series of computer instructions on any computer-readable medium, including random access memory (“RAM”), read only memory (“ROM”), flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A method for performing rank based communications, the method comprising:
encoding information onto a signal using at least two different degrees of freedom of the signal, the signal having an initial coherence matrix;
transmitting the signal though a transmission channel;
detecting the signal at a detector;
determining a resultant coherence matrix from the detected signal;
diagonalizing the resultant coherence matrix and generating a diagonalized matrix; and
determining the encoded information from the diagonalized matrix.

2. The method of claim 1, wherein the degrees of freedom include one or more of physical degrees of freedom, electromagnetic degrees of freedom, electric degrees of freedom, magnetic degrees of freedom, spatial degrees of freedom, temporal degrees of freedom, a polarization, a spin, a wavelength, a frequency, an intensity, a phase, or an angular orbital momentum.

3. The method of claim 1, wherein the initial coherence matrix comprises a 4×4 coherence matrix.

4. The method of claim 1, wherein a rank of the coherence matrix is not interconvertible via a unitary transformation.

5. The method of claim 1, wherein the transmission channel comprises a medium that performs one or more unitary transformations on the initial coherence matrix to transform the initial coherence matrix into the resultant coherence matrix.

6. The method of claim 1, wherein the transmission channel comprises a scattering medium of a medium that provides nonunitary global losses.

7. The method of claim 1, wherein the signal comprises one or more of an optical signal, a photon, an electrical signal, a magnetic signal, a qubit, a particle, an electric field, a magnetic field, or an information carrying field.

8. The method of claim 1, wherein the encoded information includes a four symbol alphabet that cannot be interconverted under any unitary transformation.

9. The method of claim 1, wherein the encoded information includes a number of alphabet symbols equal to a rank of the initial coherence matrix, and wherein the rank of the initial coherence matrix is equal to a number of non-zero eigenvalues of the initial coherence matrix.

10. The method of claim 1, wherein the degrees of freedom each comprises a binary degree of freedom.

11. A system for rank communication, the system including:
an encoder configured to encode information onto a signal using at least two degrees of freedom of the signal to generate an encoded signal having an initial coherence matrix, the encoded information include one or more symbols of a code alphabet;
a signal detector configured to detect the signal after the signal has been transmitted through a transmission channel;
an analyzer configured to:
determine a resultant coherence matrix from the detected signal, the resultant coherence matrix,
diagonalize the resultant coherence matrix to generate a diagonalized matrix, and
identify one or more symbols of the code alphabet from the diagonalized matrix.

12. The system of claim 11, wherein the encoder encodes the information onto two binary degrees of freedom simultaneously.

13. The system of claim 11, wherein the initial coherence matrix has a rank value equal to the number of non-zero eigenvalues of the initial coherence matrix, and the code alphabet have a number of symbols equal to the rank of the initial coherence matrix.

14. The system of claim 11, wherein the encoder is configured to encode the information onto two degrees of freedom of the signal, and the initial coherence matrix is a 4×4matrix with four possible ranks that are configured to be used as the symbols of the code alphabet.

15. The system of claim 14, wherein the symbols constitute a code alphabet of four symbols that cannot be interconverted under any unitary transformation.

16. The system of claim 11, wherein the signal comprises one or more of an optical signal, a photon, an electrical signal, a magnetic signal, a qubit, a particle, an electric field, a magnetic field, or an information carrying field.

17. The system of claim 11, wherein the signal comprises an optical signal, and the encoder comprises one or more of waveplates, polarizers, spatial filters, amplitude modulators, or phase modulators.

18. The system of claim 11, wherein the analyzer comprises one or more of comprises one or more of a quarter waveplate, a half waveplate, a wave plate, a polarizing beam splitter, a polarizer, a spatial filter, a beam block, or a spectral filter.

19. A system for performing coherence rank communication, the system comprising:
an analyzer configured to create a coherence matrix using degrees of freedom of an optical signal detected via an optical detector configured to detect optical signals, the signals including information that represents a coherence of the degrees of freedom of the signal,
wherein a rank of a matrix is a number of its nonzero eigenvalues, and
wherein the ranks of the coherence matrix are configured to be used as encoders or symbols of signals in optical communication schemes.

20. A system for performing coherence rank communication, the system comprising:
an encoder configured to encode information onto a signal using degrees of freedom generating a signal with a coherence matrix of the degrees of freedom,
wherein a rank of a matrix is a number of its nonzero eigenvalues, and
wherein the ranks of the coherence matrix are configured to be used as encoders or symbols of signals in optical communication schemes.
